(19) United States
(12) Patent Application Publication
(10) Pub. No.: US 2015/0371072 A1
(43) Pub. Date: Dec. 24, 2015

(54) MOBILE BARCODE INFORMATION READING SYSTEM

(71) Applicant: Marson Technology Co., Ltd., New Taipei City (TW)

(72) Inventor: Ting-Fong LIOU, New Taipei City (TW)

(21) Appl. No.: 14/310,808

(22) Filed: Jun. 20, 2014

(51) Int. Cl. G06K 7/10

(52) U.S. Cl. CPC G06K 7/10881

(57) ABSTRACT

A mobile barcode information reading system is composed of a mobile electronic device and a portable barcode scanning device. After the mobile electronic device completes information linking with the portable barcode scanning device, an operator can operate the portable barcode scanning device directly on the mobile electronic device. Therefore, the implementation of the present invention is not restricted by application site. Furthermore, a barcode information obtained can be saved and displayed directly on the mobile electronic device.

### BACKGROUND OF THE INVENTION

1. Field of the Invention

The present invention relates to a mobile barcode information reading system, more particularly to a mobile barcode information reading system which enables barcode scanning operation by performing directly though the mobile electronic device.

2. Brief Description of Prior Arts

The application range of barcode scanner is wide, for example in the field of commodity management, product management of logistics field. Conventional barcode scanner, when in use, has to be connected to computer equipment by data transmission line, so as to transfer the barcode information read by the barcode scanner to the computer equipment. As computer equipments are usually not easy to carry, the working range of a barcode scanner is often limited to be in the periphery of the computer equipment. If there is a demand coming from users to carry and operate the barcode scanner faraway, the current barcode scanner certainly is unable to meet their needs. Currently, there are portable barcode scanners available on the market, which are mainly to make the barcode scanner portion more compact and to connect it to the mobile electronic device. When users perform scanning operation with the portable barcode scanner, the barcode information obtained by the portable barcode scanner can be transferred to the mobile electronic device so that users can read it immediately. The reference documents with respect to portable barcode scanner are set forth below.
(1) Taiwanese Patent Gazette No. M463876 entitled “Touch Screen Barcode Scanner and Barcode Scanning Device having the Touch Screen Barcode Scanner”
(2) Taiwanese Patent Gazette No. M470982 entitled “Scanner”
(3) China Patent Gazette No. CN200310112395.6 entitled “Mobile Scanning and Saving Device and its Method”
(4) China Patent Gazette No. CN201220345148.5 entitled “A Mobile Barcode Reader”
(5) China Patent Gazette No. CN201320127868.9 entitled “Point of Sale Terminal Extending Module for Mobile Phone”

It is apparent to know from the above mentioned disclosures, users still use portable barcode scanner as the main operation interface and the mobile electronic device is merely used for information display or program running. However, the mobile electronic device becomes more versatile such that it can perform multi-functions by running specific programs. Therefore, the mobile electronic device should not be used merely as information display. If the mobile electronic device can be used as the main operation interface, the application range and the operationality of the barcode scanner can be enhanced. As a result, the barcode scanner will be applied in extensive consumer market effectively for public use.

### SUMMARY OF THE INVENTION

In view of the above problems, the main objective of this invention is to provide a mobile barcode information reading system which enables operator to perform barcode scanning operation directly on the operation interface of a mobile electronic device.

In order to achieve above objects, the mobile barcode information reading system of the present invention is composed of a mobile electronic device and a portable barcode scanning device. When in operation, the mobile electronic device is in information linking with the portable barcode scanning device. After a barcode scanning control module is actuated, the operator can operate the portable barcode scanning device directly through the mobile electronic device. As the mobile barcode information reading system is easy to be carried by users and is a plug-and-play system which is less susceptible to environmental restriction of application site. A barcode information obtained by the mobile electronic device can be saved and displayed directly on the screen of the mobile electronic device, so that users can read the content of the barcode information immediately. Therefore, the mobile barcode information reading system has excellent convenience.

### BRIEF DESCRIPTION OF ACCOMPANYING DRAWINGS

The present invention will be better understood by the detailed description of a preferred embodiment with reference to the accompanied drawings, in which:

FIG. 1 is a perspective view showing the appearance of the present invention.

FIG. 2 is a schematic view showing the assembly of the present invention.

FIG. 3 is a schematic view showing the block modules of the present invention.

FIG. 4 is a schematic view showing the implementation (I) of the present invention.

FIG. 5 is a schematic view showing the implementation (II) of the present invention.

FIG. 6 is a schematic view showing the implementation (III) of the present invention.

FIG. 7 is a schematic view showing the implementation (IV) of the present invention.

FIG. 8 is a schematic view showing the implementation (V) of the present invention.

FIG. 9 is another embodiment of the present invention.

### DETAILED DESCRIPTION OF PREFERRED EMBODIMENTS

The technical contents, objects and effects of the present invention will become more apparent by the detailed description of some preferred embodiments in conjunction with the accompanied drawings.

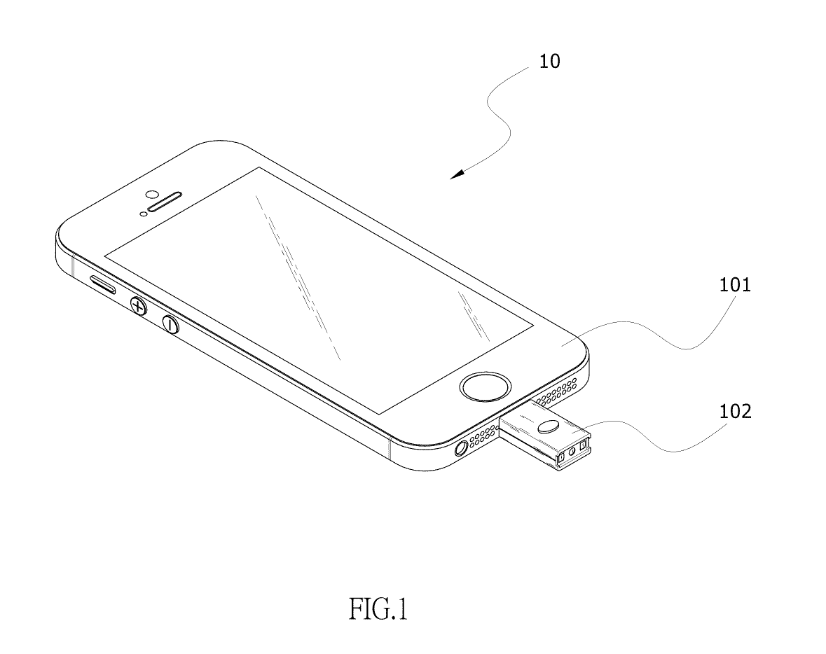

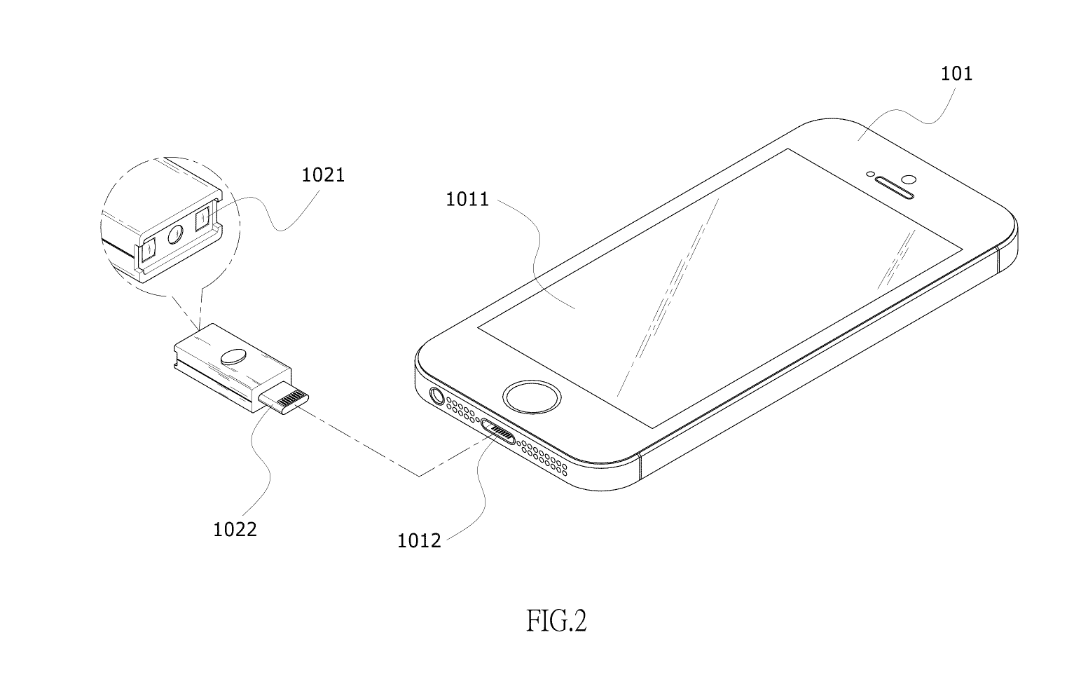

Referring to FIG. 1, the mobile barcode information reading system of the present invention is mainly composed of a mobile electronic device 101 and a portable barcode scanning device 102. After the mobile electronic device 102 is in information linking with the portable barcode scanning device 101, operator can operate the portable barcode scanning device 102 directly by the mobile electronic device 101, so as to enable the portable barcode scanning device 102 to perform barcode scanning. Referring to FIG. 2, the mobile electronic device 101 has wireless transmission function, which can be a mobile phone, a PDA, a tablet or a notebook PC. Moreover, the mobile electronic device 101 has a touch panel control unit 1011 and an information transmission port 1012. The information transmission port 1012 can be a USB (universal serial bus). The portable barcode scanning device 102 comprises a barcode scanning module 1021 and a matching information transmission plug 1022. The barcode scanning module 1021 is for scanning barcode, which comprises a light source, a lens unit, and a light receiver. The matching information transmission plug 1022 has the same transmission specification as that of the information transmission port 1012 of the mobile electronic device 101. In normal state, the mobile electronic device 101 can be independently separated from the portable barcode scanning device 102. If a barcode scanning operation is to be performed, the information transmission port 1012 can be in information linking with the matching information transmission plug 1022 so that the information linking between the mobile electronic device 101 and the portable barcode scanning device 102 is accomplished.

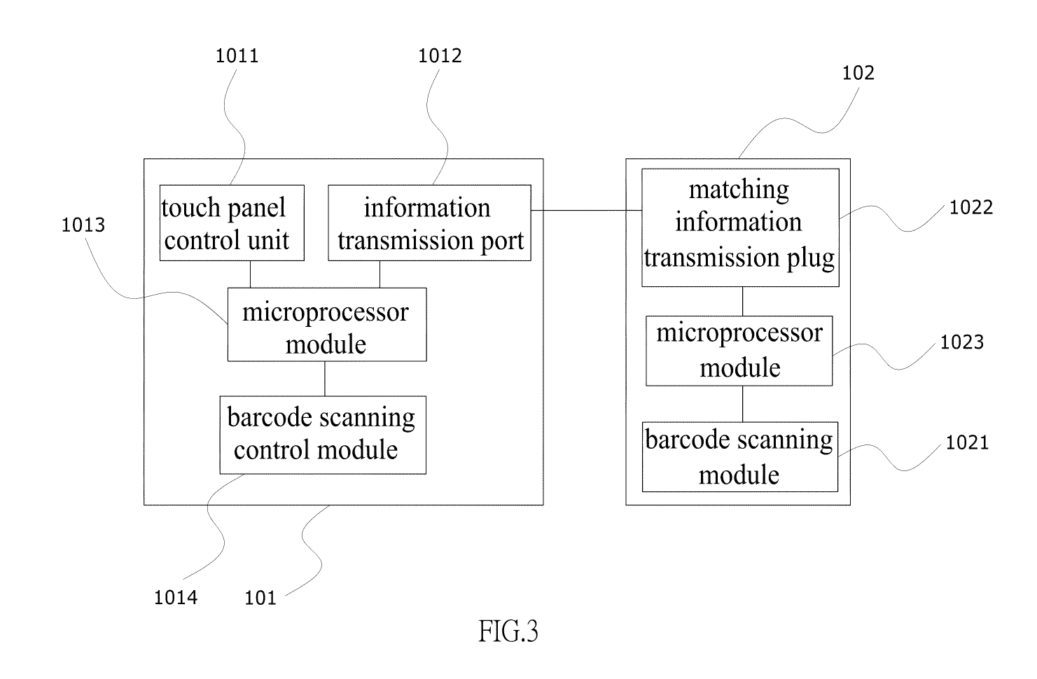

Referring to FIGS. 2 and 3, the mobile electronic device 101 further has a microprocessor module 1013, and the touch panel control unit 1011 and the information transmission port 1012 are separately in information linking with the microprocessor module 1013. A barcode scanning control module 1014 is in information linking with the microprocessor module 1013 of the mobile electronic device 101 so as to operate the portable barcode scanning device 102. The barcode scanning control module 1014 can be of the type having an application program saved in the mobile electronic device 101. After the mobile electronic device 101 completes information linking with the portable barcode scanning device 102, the operator can start the barcode scanning control module 1014 to perform scanning operation. The portable barcode scanning device 102 further has a microprocessor module 1023 for barcode decoding purpose, which is in information linking between the barcode scanning module 1021 and the matching information transmission plug 1022.

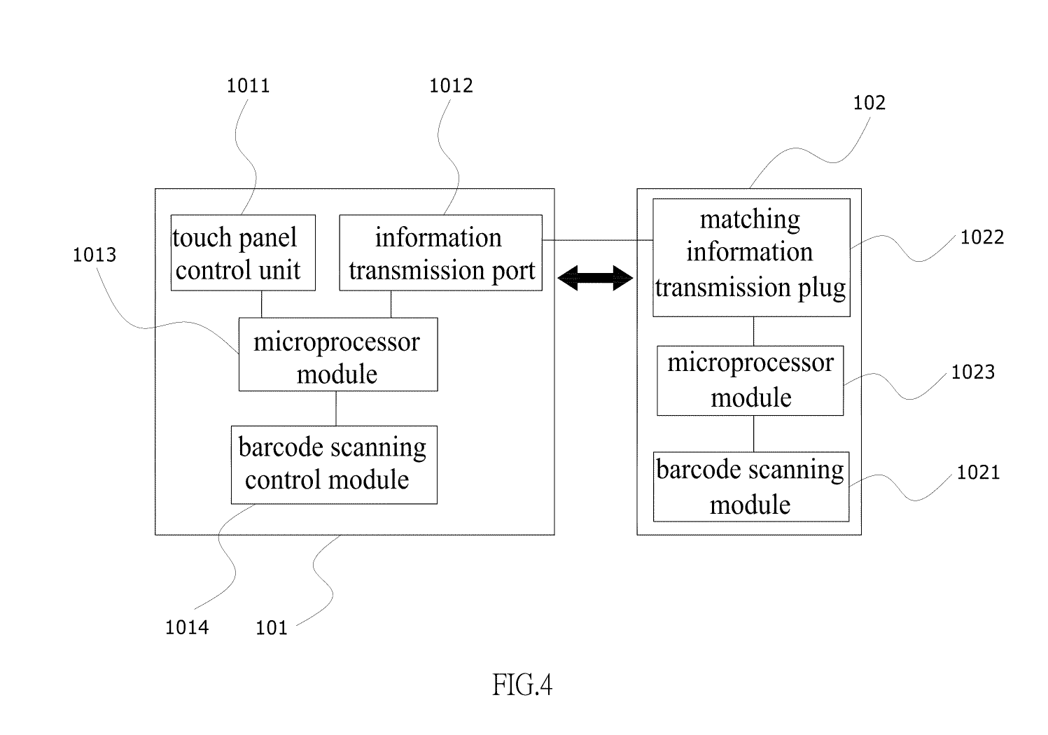

Referring to FIG. 4, when the mobile electronic device 101 is connected with the portable barcode scanning device 102, the mobile electronic device 101 will immediately execute device identification for the microprocessor module 1023. After the identification is completed, the information linking between the mobile electronic device 101 and the portable barcode scanning device 102 is completed.

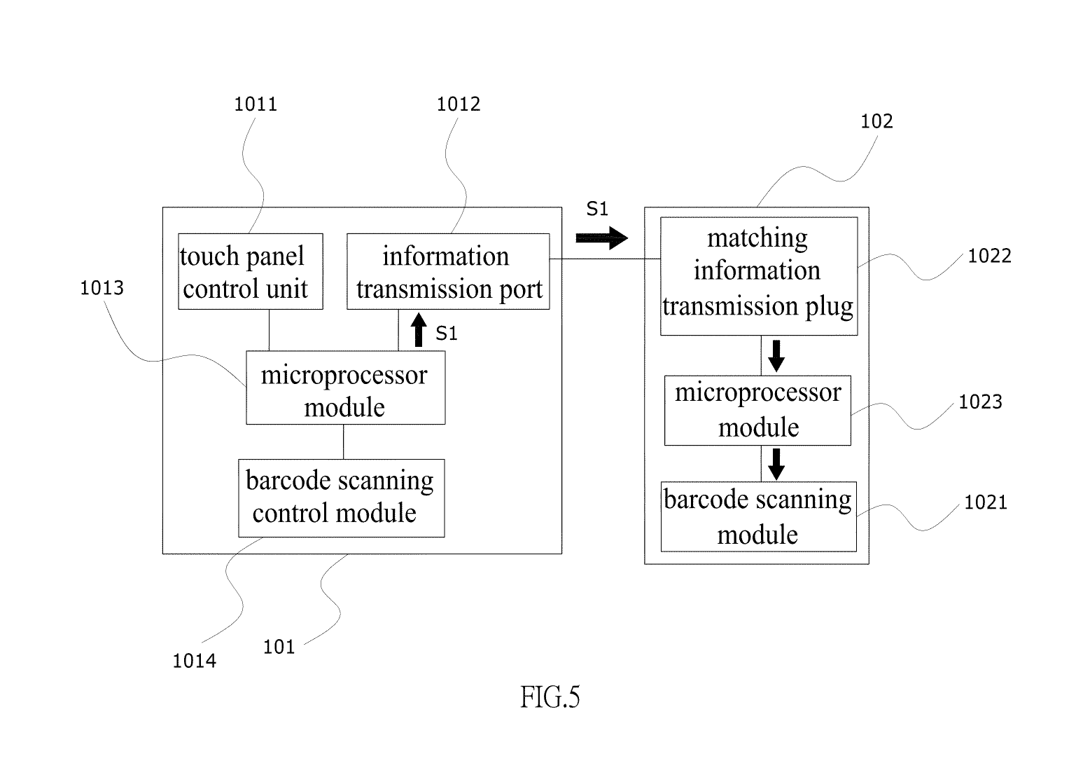

Referring to FIG. 5, when the operator starts the barcode scanning control module 1014, the barcode scanning control module 1014 will drive the microprocessor module 1013 to generate a starting signal S1, then the starting signal S1 is transmitted through the information transmission port 1012 to the matching information transmission plug 1022, so as to actuate the barcode scanning module 1021 through the microprocessor module 1023.

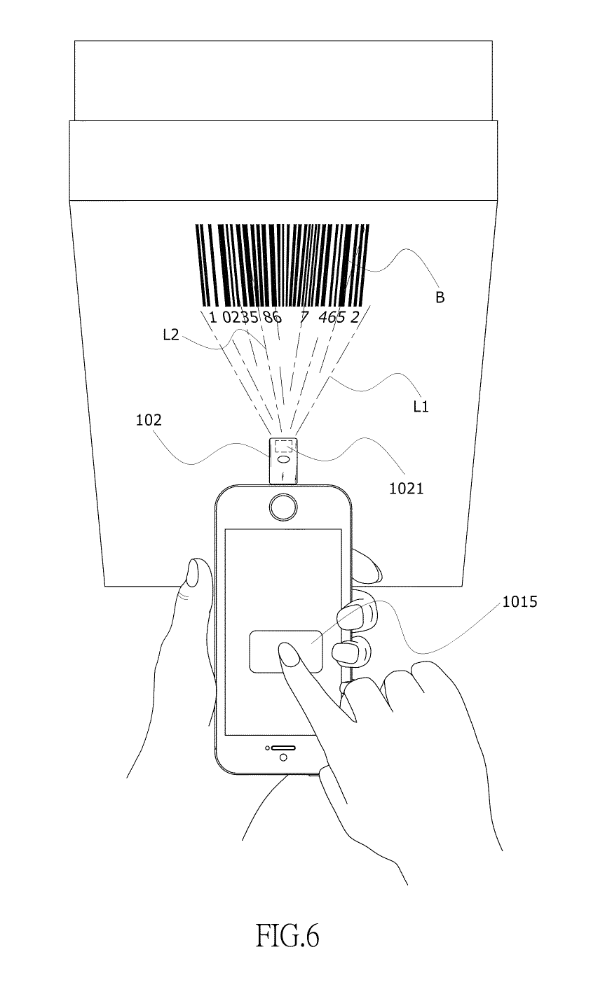

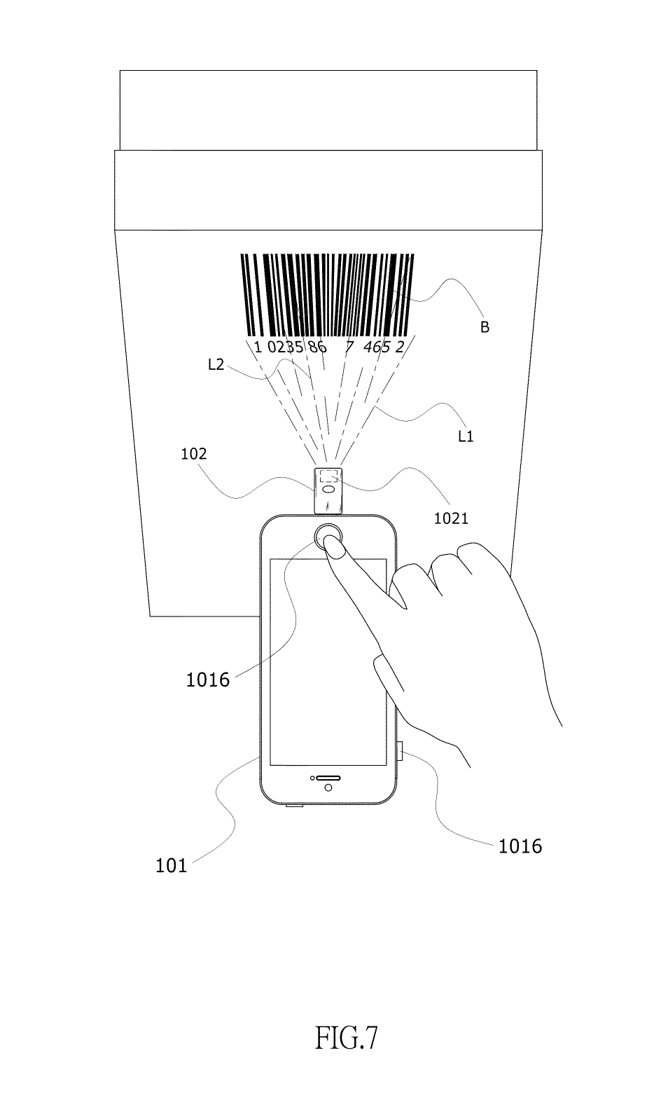

Referring to FIG. 6, when the barcode scanning module 1021 is actuated, the operator can touch a virtual operation push button 1015 of the touch panel control unit 1011 so that the barcode scanning module 1021 will emit a scanning light L1. When the scanning light L1 is aligned with a barcode B, a reflection light L2 having barcode information contained therein is generated by the barcode B and is received by the barcode scanning module 1021. Referring to FIGS. 6 and 7, the operation mode of the mobile electronic device 101 is not restricted to digital type push button, any type of operation such as physical push button operation, virtual push button operation or induction type operation mode can be employed. The operator can operate the barcode scanning control module 1014 through a physical operation push button 1016 of the mobile electronic device 101. The physical operation push button 1016 can be provided on the circumferential edge or on one plane. The above induction type operation mode can be voice control, image control, infrared control or three-axis sensing control mode. The mobile electronic device 101 can operate the barcode scanning control module 1014 by those operation mode as above mentioned. The barcode scanning control module 1014 can be installed on most types of the mobile electronic device 101 with excellent universality and without limiting the operation mode of the mobile electronic device 101.

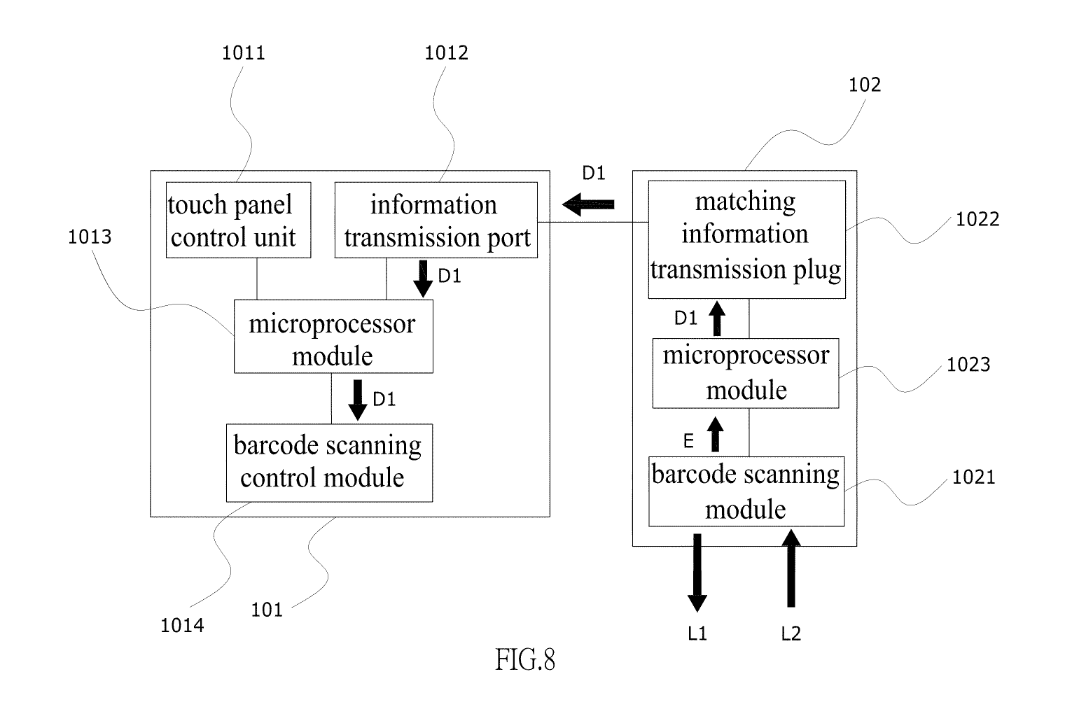

Referring to FIG. 8, the barcode scanning module 1021 receives the reflection light L2 and then transforms the reflection light L2 into an electronic signal E which is then transmitted to the microprocessor module 1023. Next, the microprocessor module 1023 performs decoding for the electronic signal E and transforms the decoded information into a barcode information D1 which is then transmitted back to the mobile electronic device 101 through the matching information transmission plug 1022.

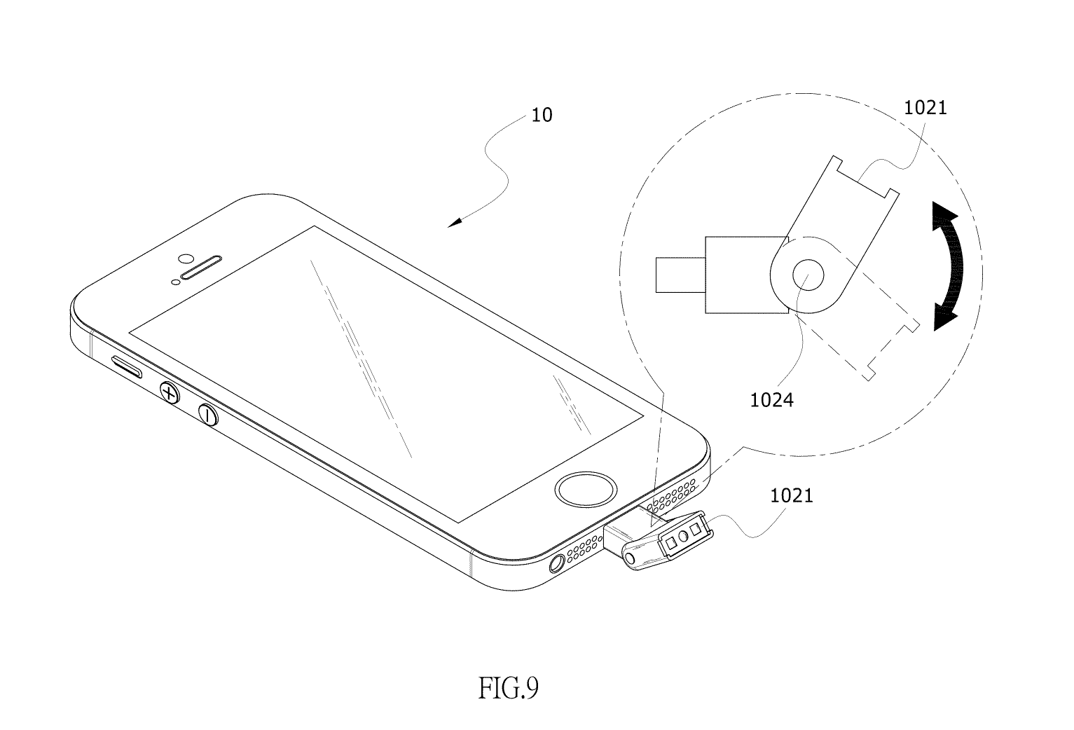

Referring to FIG. 9, the barcode scanning module 1021 is connected with the portable barcode scanning device 102 by a pivot 1024, so that the barcode scanning module 1021 and the portable barcode scanning device 102 can rotate relatively with a suitable angle. When the operation is started, the barcode scanning module 1021 is rotated by the operator so that the barcode scanning module 1021 and the barcode scanning device 102 are rotated relatively with each other, until the barcode scanning module 1021 is adjusted to a desired angle. Therefore, the portable barcode scanning device 102 can perform barcode scanning operation with an optimal scanning angle.

While the present invention has been described by preferred embodiments in conjunction with accompanying drawings, it should be understood the embodiments and the drawings are merely for descriptive and illustrative purpose, not intended for restriction of the scope of the present invention. Equivalent variations and modifications conducted by persons skilled in the art without departing from the spirit and scope of the present invention should be considered to be still within the scope of the present invention.

1. A mobile barcode information reading system for scanning a barcode, comprising:
a portable barcode scanning device including: a barcode scanning module, a microprocessor module and a matching information transmission plug; said barcode scanning module is for reading said barcode; said microprocessor module is in information linking between said barcode scanning module and said matching information transmission plug for decoding said barcode;
a mobile electronic device having another microprocessor module; and an information transmission port, a physical push button, a touch panel control unit which are separately in information linking to another said microprocessor module; said information transmission port is for information linking to said matching information transmission plug;
a barcode scanning control module which is in information linking with another said microprocessor module of said mobile electronic device;
wherein, said mobile electronic device actuates said portable barcode scanning device so that said portable barcode scanning device performs scanning for said barcode; after a barcode information is obtained by said portable barcode scanning device, said barcode information is saved and is displayed directly on the screen of said mobile electronic device.

2. The mobile barcode information reading system as claimed in claim 1, wherein said barcode scanning control module is of the type having an application program saved in said mobile electronic device; when said mobile electronic device is connected with said portable barcode scanning device, said barcode scanning control module immediately performs device identification; after the identification is completed, the information linking between said mobile electronic device and said portable barcode scanning device is completed.

3. The mobile barcode information reading system as claimed in claim 1, wherein an operator operates said physical push button after said portable barcode scanning device is in information linking with said mobile electronic device, so as to perform barcode scanning by said portable barcode scanning device.

4. The mobile barcode information reading system as claimed in claim 1, wherein an operator touches a virtual push button of said touch panel control unit after said portable barcode scanning device is in information linking with said mobile electronic device, so as to perform barcode scanning by said portable barcode scanning device.

5. The mobile barcode information reading system as claimed in claim 1, wherein said barcode scanning module is connected with said portable barcode scanning device through a pivot, so that said barcode scanning module and said portable barcode scanning device are rotated relatively with an angle which required by users.
